(19) United States
(12) Patent Application Publication
(10) Pub. No.: US 2026/0142593 A1
(43) Pub. Date: May 21, 2026

(54) MOTOR CONTROL APPARATUS, PRINTING APPARATUS, AND MOTOR CONTROL METHOD

(71) Applicant: CANON KABUSHIKI KAISHA, Tokyo (JP)

(72) Inventor: KEIJI HARADA, Kanagawa (JP)

(21) Appl. No.: 19/387,771

(22) Filed: Nov. 13, 2025

(30) Foreign Application Priority Data
Nov. 19, 2024 (JP) 2024-201702

(51) Int. Cl. H02P 3/12; B41J 2/165; B41J 13/00; B41J 25/00

(52) U.S. Cl. CPC H02P 3/12; B41J 2/16517; B41J 13/0018; B41J 25/001

(57) ABSTRACT

To make it possible to give a drive command and a brake command to a motor using a small number of control signals. For this purpose, a motor control apparatus for controlling a motor via a drive circuit includes a generation unit for generating a short-circuit brake signal for applying a short-circuit brake to the motor in a case where a control signal for controlling the motor instructs a stop of the motor, and an instruction unit for outputting an instruction for the short-circuit brake to the drive circuit in a case where the short-circuit brake signal is being generated, and outputting an instruction based on the control signal to the drive circuit in a case where the short-circuit brake signal is not being generated.

### BACKGROUND

### Field of the Technology

The present disclosure relates to a motor control apparatus, a printing apparatus, and a motor control method.

### Description of the Related Art

Conventionally, a DC motor control apparatus using an H-bridge circuit has been proposed. For example, Japanese Patent Laid-Open No. 2013-054244 proposes an apparatus that drives and brakes a brushless DC motor.

However, in Japanese Patent Laid-Open No. 2013-054244, in a case where driving the brushless DC motor, it is necessary to generate a PWM signal in a PWM signal generation unit and supply the PWM signal to a motor driver IC. In a case where braking the brushless DC motor, it is necessary to generate a BRK signal in a BRK signal generation unit and supply the BRK signal to the motor driver IC. For this reason, a signal generation unit, a signal terminal, and a signal receiving unit are necessary for each of driving and braking. Furthermore, in a motor driver IC that incorporates N motor drive circuits, N times the hardware is necessary.

### SUMMARY

The present disclosure has been made in view of the above-described problems, and an object thereof is to make it possible to give a drive command and a brake command to a motor using a small number of control signals.

In an aspect of the present disclosure, there is provided a motor control apparatus for controlling a motor via a drive circuit, the motor control apparatus comprising: a generation unit configured to generate a short-circuit brake signal for applying a short-circuit brake to the motor in a case where a control signal for controlling the motor instructs a stop of the motor; and an instruction unit configured to output an instruction for the short-circuit brake to the drive circuit in a case where the short-circuit brake signal is being generated, and to output an instruction based on the control signal to the drive circuit in a case where the short-circuit brake signal is not being generated.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are perspective views illustrating a printer;

FIG. 2 is a diagram illustrating a processor, an H-bridge control unit group, four systems of H-bridge circuits, and DC motors;

FIG. 3 is a diagram illustrating an H-bridge control unit, an H-bridge circuit, and a DC motor according to a first embodiment;

FIG. 4 is an input/output truth table of an instruction unit of the first embodiment.

FIG. 5 is a timing diagram illustrating an operation of the circuit illustrated in FIG. 3 in a case where a duty detection unit is invalidated;

FIG. 6 is a timing diagram illustrating an operation of the circuit illustrated in FIG. 3 in a case where a duty detection unit is enabled;

FIG. 7 is a flowchart for explaining a method for stopping a motor.

FIG. 8 is a diagram illustrating an H-bridge control unit, an H-bridge circuit, and a DC motor according to a second embodiment;

FIG. 9 is an input/output truth table of an instruction unit of the second embodiment;

FIG. 10 is a timing diagram illustrating an operation of the circuit illustrated in FIG. 8 in a case where a duty detection unit is invalidated;

FIG. 11 is a timing diagram illustrating an operation of the circuit illustrated in FIG. 8 in a case where a duty detection unit is enabled; and

FIGS. 12A to 12D are input/output truth tables of an instruction unit of other embodiments.

### DESCRIPTION OF THE EMBODIMENTS

Hereinafter, embodiments will be described in detail with reference to the accompanying drawings. The following embodiments do not limit the disclosure according to the claims. Although a plurality of features are described in the embodiments, not all of these plural features are essential to the disclosure, and the plural features may be arbitrarily combined. Furthermore, in the accompanying drawings, identical or similar configurations are denoted by identical reference numerals, and a repeated description will be omitted.

### First Embodiment

Next, an embodiment in which the present disclosure is applied to a multifunction inkjet printer (also simply referred to as a “printer”) will be described below.

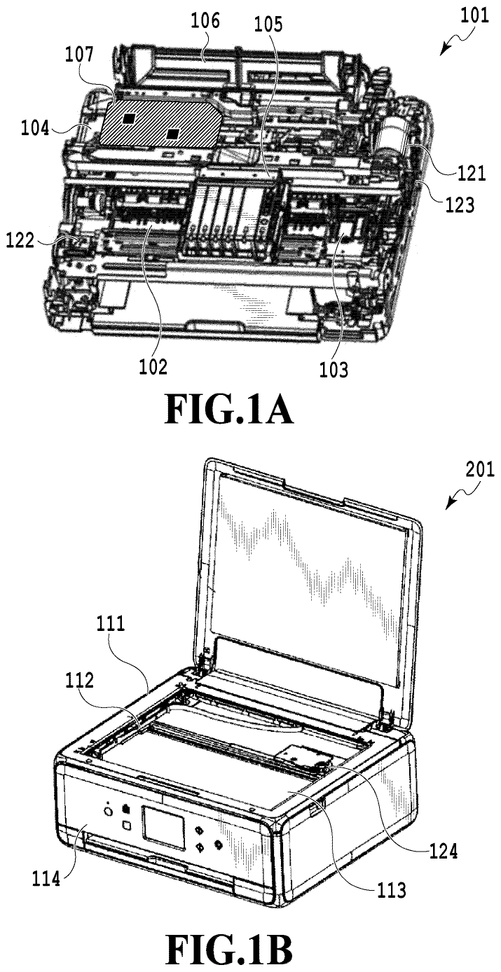

First, an overall configuration is illustrated in FIGS. 1A and 1B. FIG. 1A illustrates a perspective view of a printer 101. Referring to FIG. 1A, the printer 101 includes a conveyance mechanism 102 that conveys a printing medium, an LF motor 122 that moves the conveyance mechanism 102, and a cleaning mechanism 103 that cleans nozzles of a printing head (not illustrated). The printer 101 also includes a carriage 105 on which the printing head is mounted, a CR motor 121 that moves the carriage 105 on which the printing head is mounted, and an automatic conveyance mechanism 106 that takes out only one sheet from a top portion from a plurality of printing media and sends the sheet to the printer. Furthermore, the printer 101 includes an APP motor 123 that moves the cleaning mechanism 103 and the automatic conveyance mechanism 106, an AC adapter 104, and a control substrate 107 that controls the entire printer 101.

FIG. 1B is a perspective view illustrating the printer 101 in a state in which an image reading unit 111, a panel unit 114, and the like are incorporated. The image reading unit 111 is configured to include an image reading sensor 112 for reading an image from a document, an FB motor 124 that moves the image reading sensor 112, and a platen glass 113 on which the document is placed.

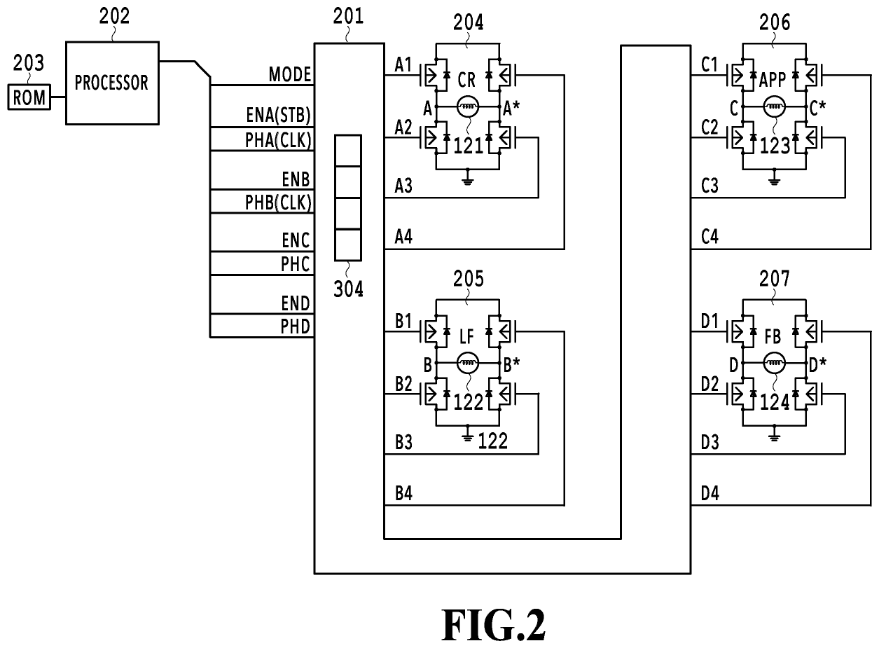

FIG. 2 is a diagram illustrating a processor, an H-bridge control unit group, four systems of H-bridge circuits (also referred to as “drive circuits”), and DC motors.

The printer 101 includes a processor 202 such as a CPU, a ROM 203, and an H-bridge control unit group 201. The printer 101 also includes four systems of H-bridge circuits 204 to 207. The processor 202 and the H-bridge control unit group 201 control a CR motor 121, an LF motor 122, an APP motor 123, and an FB motor 124 via the four systems of H-bridge circuits 204 to 207.

The processor 202 outputs a motor control signal and an operation mode switching signal MODE to the H-bridge control unit group 201 based on firmware stored in the ROM 203. Here, the motor control signal includes a motor energization permission signal ENx and a motor rotation switching signal PHx (described later, x is A, B, C, D).

The processor 202 performs writing of a setting to a short-circuit brake permission flag register 304 prior to motor driving.

Here, a part of the motor control signals (that is, signal lines of ENA, PHA, and PHB) function as a strobe, a clock, and a data signal, respectively, in a case where the operation mode switching signal MODE is at a Low level. Therefore, in order to perform writing of the setting to the short-circuit brake permission flag register 304, the processor 202 sets the operation mode switching signal MODE to Low and performs three-wire serial interface communication with the H-bridge control unit group 201.

Signal lines such as ENx, PHx (x=A, B, C, and D) function as lines for signals described below in a case where the operation mode switching signal MODE is at a High level.

The motor energization permission signal ENx is a binary signal that indicates whether energization of a motor x is permitted, indicates that energization is not permitted in a case where the signal is in a Low state, and indicates that energization is permitted in a case where the signal is in a High state.

The motor rotation switching signal PHx is a PWM signal, and determines an energization direction of a motor x according to a signal level and determines an energization amount of the motor x according to a duty. For example, in a case where an energization direction in a case of the signal level being in a Low state is CW and an energization direction in a case of the signal level being in a High state is CCW, the following is obtained. That is, an average energization amount to the motor x in a case where a PWM duty (a ratio of a High state with respect to a period) is 40 percent is 20 percent in a CW direction ((50−40)/50=0.2) (a ratio with respect to a maximum energization amount, the same applies hereinafter). An average energization amount to the motor x in a case where the duty is 50 percent is zero. An average energization amount to the motor x in a case where the duty is 70 percent is 40 percent in a CCW direction ((70−50)/50=0.4). The PWM signal is a periodic signal that is generally repeated with a PWM period.

Furthermore, in a case where a setting value of a short-circuit brake flag register 304 in the H-bridge control unit group 201 indicates that a short-circuit brake is enabled, a motor x is subjected to a short-circuit brake (short brake).

The H-bridge control unit group 201 outputs power transistor control signals A1 to A4, B1 to B4, C1 to C4, and D1 to D4 of H-bridge circuits 204 to 207 based on a motor control signal output from the processor 202. Here, the motor control signal includes the motor energization permission signal ENx and the motor rotation switching signal PHx. That is, the H-bridge control unit group 201 outputs power transistor control signals A1 to A4 of the H-bridge circuit 204 based on a motor control signal (a motor energization permission signal ENA and a motor rotation switching signal PHA) output from the processor 202. The H-bridge control unit group 201 outputs power transistor control signals B1 to B4 of an H-bridge circuit 205 based on a motor control signal (a motor energization permission signal ENB and a motor rotation switching signal PHB) output from the processor 202. Furthermore, the H-bridge control unit group 201 outputs power transistor control signals C1 to C4 of an H-bridge circuit 206 based on a motor control signal (a motor energization permission signal ENC and a motor rotation switching signal PHC) output from the processor 202. Furthermore, the H-bridge control unit group 201 outputs power transistor control signals D1 to D4 of an H-bridge circuit 207 based on a motor control signal (a motor energization permission signal END and a motor rotation switching signal PHD) output from the processor 202.

The H-bridge circuits 204 to 207 directly perform energization control of motors 121 to 124 based on control signals A1 to A4, B1 to B4, C1 to C4, and D1 to D4 output from the H-bridge control unit group 201. That is, the H-bridge circuit 204 directly performs energization control of the motor 121 based on the control signals A1 to A4 output from the H-bridge control unit group 201. The H-bridge circuit 205 directly performs energization control of the motor 122 based on the control signals B1 to B4 output from the H-bridge control unit group 201. Furthermore, the H-bridge circuit 206 directly performs energization control of the motor 123 based on the control signals C1 to C4 output from the H-bridge control unit group 201. Furthermore, the H-bridge circuit 207 directly performs energization control of the motor 124 based on the control signals D1 to D4 output from the H-bridge control unit group 201.

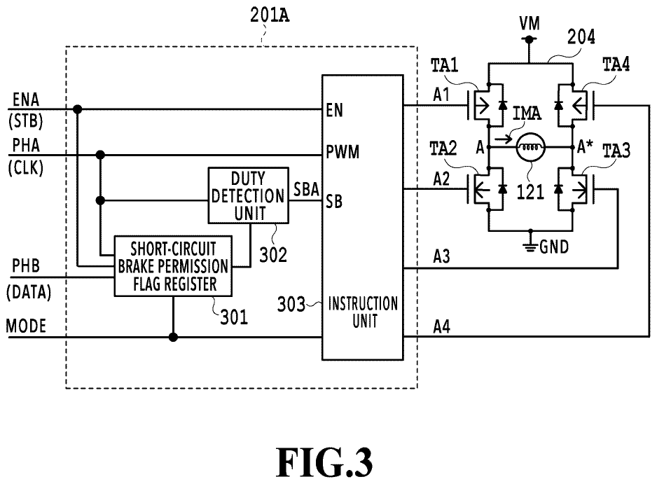

Next, details of an H-bridge control unit 201A included in the H-bridge control unit group 201 are illustrated in FIG. 3.

FIG. 3 illustrates a portion related to the H-bridge control unit 201A among H-bridge control units 201A to 201D included in the H-bridge control unit group 201. That is, FIG. 3 illustrates a portion that outputs control signals A1 to A4 to the H-bridge circuit 204. Portions related to H-bridge control units 201B to 201D also have a configuration similar to the portion related to the H-bridge control unit 201A.

The H-bridge control unit 201A outputs power transistor control signals A1 to A4 to the H-bridge circuit 204 based on a motor control signal (a motor energization permission signal ENA and a motor rotation switching signal PHA) input from the processor 202.

In a case where a setting value of a flag stored in a short-circuit brake permission flag register 301 is 1 (High) indicating permission, a duty detection unit (also referred to as “generation unit”) 302 operates as follows. That is, the duty detection unit 302 monitors a PWM duty of the motor rotation switching signal PHA, and in a case where it is detected that the PWM duty is 50 percent, sets a signal level of a short-circuit brake signal SBA to High. The duty detection unit 302 sets the signal level of the short-circuit brake signal SBA to Low in a case where it is detected that the PWM duty is other than 50 percent. The short-circuit brake signal SBA is supplied to a short-circuit brake input terminal SB of an instruction unit 303. Here, that the PWM duty of the motor rotation switching signal PHA as a motor control signal is 50 percent means that the motor rotation switching signal PHA instructs a stop. The short-circuit brake signal SBA instructs to apply short-circuit control to the motor in a case where the signal level is High. Therefore, in a case where the duty detection unit 302 determines that the motor rotation switching signal PHA instructs a stop of the motor, the duty detection unit 302 instructs to apply a short-circuit brake to the motor by the short-circuit brake signal SBA.

In a case where the setting value of the short-circuit brake permission flag register 301 is 0 (Low) indicating prohibition, the signal level of the short-circuit brake signal SBA is always at a Low level.

The instruction unit 303 issues an instruction to the H-bridge circuit 204 based on the motor control signal input from the processor 202 and the short-circuit brake signal SBA input from the duty detection unit 302. Here, the motor control signal includes the motor energization permission signal ENA and the motor rotation switching signal PHA. The instruction is indicated by power transistor control signals A1 to A4 of the H-bridge circuit 204.

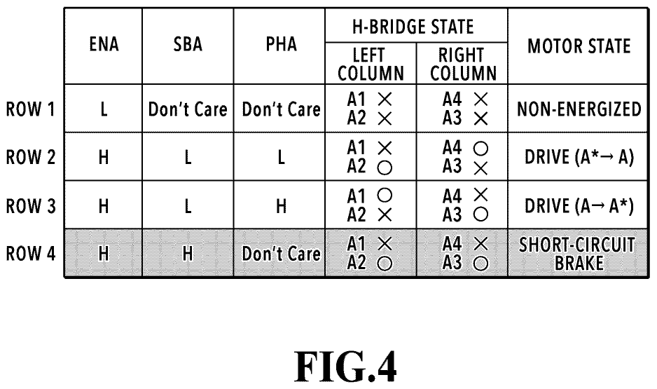

FIG. 4 shows an input/output truth table of the instruction unit 303. The first embodiment is an application of a so-called PHASE chopping scheme that performs energization amount control of a DC brush motor according to the duty of the motor rotation switching signal PHA. Therefore, the input/output truth table illustrated in FIG. 4 conforms to the PHASE chopping scheme.

In an “H-bridge state” column of the truth table, “□” indicates that a signal level of a power transistor control signal Ax (x=1 to 4) is a signal level that turns off a power transistor TAx. “◯” indicates that the signal level of the power transistor control signal Ax (x=1 to 4) is a signal level that turns on the power transistor TAx. Hereinafter, the signal level of the power transistor control signal Ax will be described in place of on (◯) and off (□) of the power transistor TAx.

First, a first row of the truth table indicates that in a case where the motor energization permission signal ENA is at a Low level, the power transistors TA1 to TA4 are turned off regardless of the levels of the motor rotation switching signal PHA and the short-circuit brake signal SBA (Don't Care). In this case, two input terminals of the motor 121 become non-energized (that is, open).

A second row of the truth table indicates the following. That is, it indicates that energization to the motor is in a possible state because the motor energization permission signal ENA is at a High level. It also indicates that a short-circuit brake instruction is in an invalid state because the short-circuit brake signal SBA is at a Low level. Furthermore, it indicates that power transistors TA2 and TA4 are on (◯) and power transistors TA1 and TA3 are off (□) because the motor rotation switching signal PHA is at a Low level. Referring to FIG. 3, in this case, a current flows from a power supply VM to GND via the power transistor TA4, the motor 121, and the power transistor TA2. That is, a current IMA flows through the motor 121 in a direction from a terminal A* to a terminal A. Here, the terminal A and the terminal A* are input terminals for driving.

A third row of the truth table indicates the following. That is, it indicates that energization to the motor is in a possible state because the motor energization permission signal ENA is at a High level. It also indicates that a short-circuit brake instruction is in an invalid state because the short-circuit brake signal SBA is at a Low level. Furthermore, it indicates that power transistors TA1 and TA3 are on (◯) and power transistors TA2 and TA4 are off (□) because the motor rotation switching signal PHA is at a High level. Referring to FIG. 3, in this case, a current flows from the power supply VM to GND via the power transistor TA1, the motor 121, and the power transistor TA3. That is, a current IMA flows through the motor 121 in a direction from the terminal A to the terminal A*.

A fourth row of the truth table indicates the following. That is, it indicates that energization to the motor is in a possible state because the motor energization permission signal ENA is at a High level. It also indicates that a short-circuit brake instruction is in an enabled state because the short-circuit brake signal SBA is at a High level. For this reason, it indicates that power transistors TA2 and TA3 are on (◯) and power transistors TA1 and TA4 are off (□) regardless of the level of the motor rotation switching signal PHA (Don't Care). Referring to FIG. 3, in this case, a closed circuit of the power transistor TA2, the motor 121, the power transistor TA3, and GND is formed. That is, the terminal A and the terminal A* of the motor 121 enter a short-circuited state.

Other H-bridge control units (not illustrated) that output control signals B1 to B4, C1 to C4, and D1 to D4 to other H-bridge circuits 205 to 207 are similar to the H-bridge control unit 201A, and therefore a repeated description will be omitted.

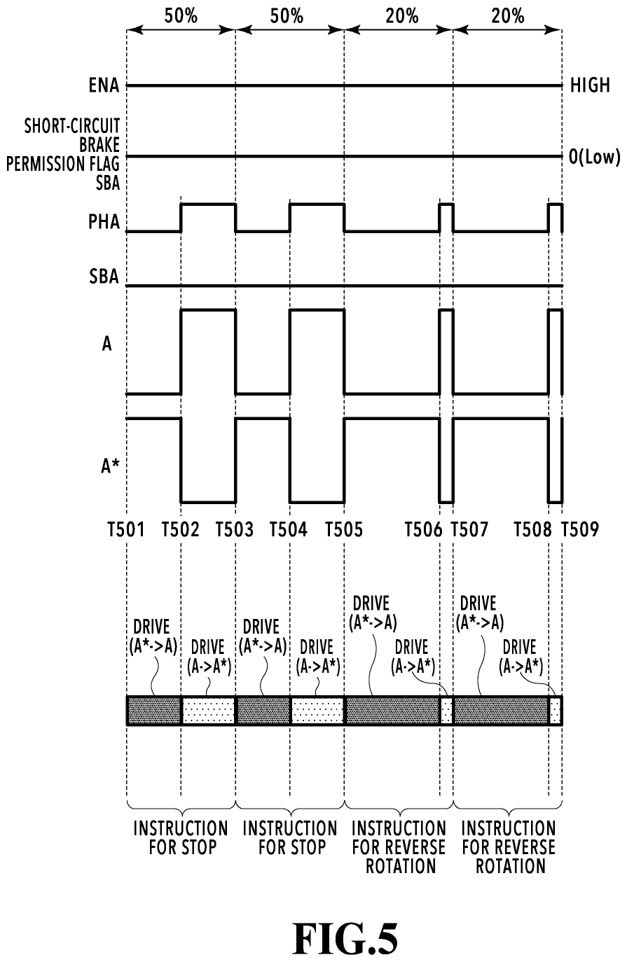

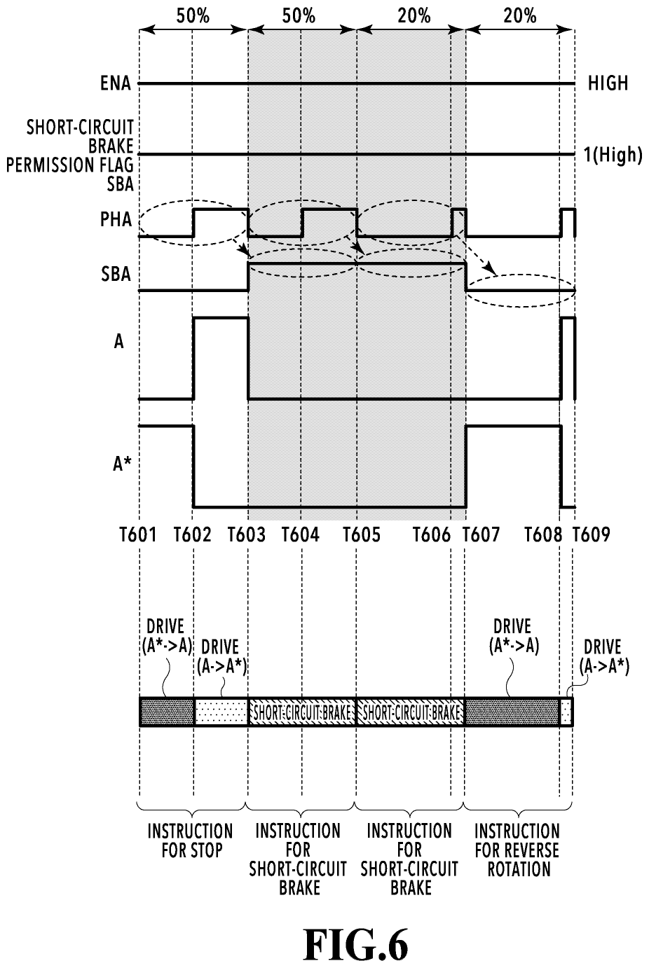

Next, an operation of the H-bridge control unit, the H-bridge circuit, and the DC motor according to the present embodiment will be described with reference to FIG. 5 and FIG. 6.

First, an operation in a case where the duty detection unit 302 is invalidated will be described with reference to FIG. 5. FIG. 5 is a timing diagram illustrating an operation of the circuit illustrated in FIG. 3 in a case where the motor energization permission signal ENA is at a High level and a setting value of the short-circuit brake permission flag register 301 is 0 (Low). In this case, because the setting value of the short-circuit brake permission flag register 301 is 0 (Low), the duty detection unit 302 is invalidated. Therefore, the signal level of the short-circuit brake signal SBA is always at a Low level.

First, in a period from time T501 to time T502, the motor rotation switching signal PHA is at a Low level. Therefore, in the period from time T501 to time T502, the motor energization permission signal ENA is at a High level, the short-circuit brake signal SBA is at a Low level, and the motor rotation switching signal PHA is at a Low level. This is the same as the state of the second row of the truth table. Therefore, the instruction unit 303 sets the power transistor control signals A1 to A4 such that the power transistors TA2 and TA4 are turned on (◯) and the power transistors TA1 and TA3 are turned off (□). As a result, a terminal A of a motor 131 becomes a GND level, and a terminal A* becomes a VM level. Therefore, a current flows from the terminal A* toward the terminal A.

Next, in a period from time T502 to time T503, the motor rotation switching signal PHA is at a High level. Therefore, in the period from time T502 to time T503, the motor energization permission signal ENA is at a High level, the short-circuit brake signal SBA is at a Low level, and the motor rotation switching signal PHA is at a High level. This is the same as the state of the third row of the truth table. Therefore, the instruction unit 303 sets the power transistor control signals A1 to A4 such that the power transistors TA1 and TA3 are turned on (◯) and the power transistors TA2 and TA4 are turned off (□). As a result, the terminal A of the motor 131 becomes a VM level, and the terminal A* becomes a GND level. Therefore, a current flows from the terminal A toward the terminal A*.

A ratio between a period in which the motor energization permission signal ENA is at a High level and the short-circuit brake signal SBA is at a Low level, and a period in which this is reversed, is adjusted to match a ratio between a period in which the motor rotation switching signal PHA is at a Low level and a period in which the signal is at a High level.

Thereafter, similarly to a period from time T503 to time T509, the terminal A of the motor 131 becomes a GND level and the terminal A* becomes a VM level in a case where the motor rotation switching signal PHA is at a Low level. In a case where the motor rotation switching signal PHA is at a High level, the terminal A of the motor 131 becomes a VM level, and the terminal A* becomes a GND level.

In a period from time T501 to time T503, a duty of the motor rotation switching signal PHA, which is a PWM signal, is 50 percent. Therefore, in the period from time T501 to time T503, the motor rotation switching signal PHA instructs a “stop.”

In a period from time T503 to time T505, a duty of the motor rotation switching signal PHA is 50 percent. Therefore, in the period from time T503 to time T505, the motor rotation switching signal PHA instructs a “stop.”

In a period from time T505 to time T507, a duty of the motor rotation switching signal PHA is 20 percent. Therefore, in the period from time T505 to time T507, the motor rotation switching signal PHA instructs a “reverse rotation.”

In a period from time T507 to time T509, a duty of the motor rotation switching signal PHA is 20 percent. Therefore, in the period from time T507 to time T509, the motor rotation switching signal PHA instructs a “reverse rotation.”

Next, an operation in a case where the duty detection unit 302 is enabled will be described with reference to FIG. 6. FIG. 6 is a timing diagram illustrating an operation of the circuit illustrated in FIG. 3 in a case where the motor energization permission signal ENA is at a High level and a setting value of the short-circuit brake permission flag register 301 is 1 (High). In this case, because the setting value of the short-circuit brake permission flag register 301 is 1 (High), the duty detection unit 302 is enabled. Therefore, the short-circuit brake signal SBA becomes a High level or a Low level according to the duty of the motor rotation switching signal PHA. Specifically, the short-circuit brake signal SBA becomes a High level if the duty of the motor rotation switching signal PHA is 50 percent, and becomes a Low level otherwise.

First, in a period from time T601 to time T602, the motor rotation switching signal PHA is at a Low level. Although not illustrated, in a PWM period before a PWM period from time T601 to time T603, a duty of the motor rotation switching signal PHA is not 50 percent. Therefore, in a period from time T601 to time T603, the short-circuit brake signal SBA is at a Low level. Therefore, in the period from time T601 to time T602, the motor energization permission signal ENA is at a High level, the short-circuit brake signal SBA is at a Low level, and the motor rotation switching signal PHA is at a Low level. This is the same as the state of the second row of the truth table. Therefore, the instruction unit 303 outputs an instruction corresponding to this to the H-bridge circuit 204. The H-bridge circuit 204 performs setting such that the power transistors TA2 and TA4 are turned on (◯) and the power transistors TA1 and TA3 are turned off (□), according to power transistor control signals A1 to A4 included in the instruction. As a result, a terminal A of a motor 131 becomes a GND level, and a terminal A* becomes a VM level. Therefore, a current flows from the terminal A* toward the terminal A.

In a period from time T602 to time T603, the motor rotation switching signal PHA is at a High level. Although not illustrated, as described above, in the PWM period before the PWM period from time T601 to time T603, the duty of the motor rotation switching signal PHA is not 50 percent. Therefore, in the period from time T601 to time T603, the short-circuit brake signal SBA is at a Low level. Therefore, in the period from time T602 to time T603, the motor energization permission signal ENA is at a High level, the short-circuit brake signal SBA is at a Low level, and the motor rotation switching signal PHA is at a High level. This is the same as the state of the third row of the truth table. Therefore, the instruction unit 303 outputs an instruction corresponding to this to the H-bridge circuit 204. The H-bridge circuit 204 performs setting such that the power transistors TA1 and TA3 are turned on (◯) and the power transistors TA2 and TA4 are turned off (□), according to the power transistor control signals A1 to A4 included in the instruction. As a result, the terminal A* of the motor 131 becomes a GND level, and the terminal A becomes a VM level. Therefore, a current flows from the terminal A toward the terminal A*.

In a period from time T603 to time T604, the motor rotation switching signal PHA is at a Low level. In the PWM period from time T601 to time T603, the duty of the motor rotation switching signal PHA is 50 percent. Therefore, in a period from time T603 to time T605, the short-circuit brake signal SBA is at a High level. Therefore, in the period from time T603 to time T604, the motor energization permission signal ENA is at a High level, the short-circuit brake signal SBA is at a High level, and the motor rotation switching signal PHA is at a Low level. This is the same as the state of the fourth row of the truth table. Therefore, the instruction unit 303 outputs an instruction corresponding to this to the H-bridge circuit 204. The H-bridge circuit 204 performs setting such that the power transistors TA2 and TA3 are turned on (◯) and the power transistors TA1 and TA4 are turned off (□), according to the power transistor control signals A1 to A4 included in the instruction. As a result, the terminal A of the motor 131 becomes a GND level, and the terminal A* becomes a GND level. Therefore, the terminal A* and the terminal A are short-circuited. As a result, a short-circuit brake is applied to the motor 121.

A state in a period from time T604 to time T605 differs from a state in a period from time T603 to time T604 only in a point that the motor rotation switching signal PHA changes from Low to High. Therefore, the state becomes the state of the fourth row of the truth table. Therefore, the instruction unit 303 outputs an instruction corresponding to this to the H-bridge circuit 204. The H-bridge circuit 204 performs setting such that the power transistors TA2 and TA3 are turned on (◯) and the power transistors TA1 and TA4 are turned off (□), according to the power transistor control signals A1 to A4 included in the instruction. As a result, the terminal A of the motor 131 becomes a GND level, and the terminal A* becomes a GND level. Therefore, the terminal A* and the terminal A are short-circuited. As a result, a short-circuit brake is applied to the motor 121.

In a period from time T605 to time T606, the motor rotation switching signal PHA is at a Low level. In the PWM period from time T603 to time T605, the duty of the motor rotation switching signal PHA is 50 percent. Therefore, in a period from time T605 to time T607, the short-circuit brake signal SBA is at a High level. Therefore, in the period from time T605 to time T606, the motor energization permission signal ENA is at a High level, the short-circuit brake signal SBA is at a High level, and the motor rotation switching signal PHA is at a Low level. This is the same as the state of the fourth row of the truth table. Therefore, the instruction unit 303 outputs an instruction corresponding to this to the H-bridge circuit 204. The H-bridge circuit 204 performs setting such that the power transistors TA2 and TA3 are turned on (◯) and the power transistors TA1 and TA4 are turned off (□), according to the power transistor control signals A1 to A4 included in the instruction. As a result, the terminal A of the motor 131 becomes a GND level, and the terminal A* becomes a GND level. Therefore, the terminal A* and the terminal A are short-circuited. As a result, a short-circuit brake is applied to the motor 121.

A state in a period from time T606 to time T607 differs from a state in a period from time T605 to time T606 only in a point that the motor rotation switching signal PHA changes from Low to High. Therefore, the state becomes the state of the fourth row of the truth table. Therefore, the instruction unit 303 outputs an instruction corresponding to this to the H-bridge circuit 204. The H-bridge circuit 204 performs setting such that the power transistors TA2 and TA3 are turned on (◯) and the power transistors TA1 and TA4 are turned off (□), according to the power transistor control signals A1 to A4 included in the instruction. As a result, the terminal A of the motor 131 becomes a GND level, and the terminal A* becomes a GND level. Therefore, the terminal A* and the terminal A are short-circuited. As a result, a short-circuit brake is applied to the motor 121.

In a period from time T607 to time T608, the motor rotation switching signal PHA is at a Low level. In the PWM period from time T605 to time T607, the duty of the motor rotation switching signal PHA is 20 percent. Therefore, in a period from time T607 to time T609, the short-circuit brake signal SBA is at a Low level. Therefore, in the period from time T607 to time T608, the motor energization permission signal ENA is at a High level, the short-circuit brake signal SBA is at a Low level, and the motor rotation switching signal PHA is at a Low level. This is the same as the state of the second row of the truth table. Therefore, the instruction unit 303 outputs an instruction corresponding to this to the H-bridge circuit 204. The H-bridge circuit 204 performs setting such that the power transistors TA2 and TA4 are turned on (◯) and the power transistors TA1 and TA3 are turned off (□), according to the power transistor control signals A1 to A4 included in the instruction. As a result, the terminal A of the motor 131 becomes a GND level, and the terminal A* becomes a VM level. Therefore, a voltage of the terminal A* becomes higher than a voltage of the terminal A, and a current IMA flows from the terminal A* to the terminal A.

A state in a period from time T608 to time T609 differs from a state in a period from time T605 to time T606 only in a point that the motor rotation switching signal PHA changes from Low to High. Therefore, the state becomes the state of the third row of the truth table. Therefore, the instruction unit 303 outputs an instruction corresponding to this to the H-bridge circuit 204. The H-bridge circuit 204 performs setting such that the power transistors TA1 and TA3 are turned on (◯) and the power transistors TA2 and TA4 are turned off (□), according to the power transistor control signals A1 to A4 included in the instruction. As a result, the terminal A of the motor 131 becomes a VM level, and the terminal A* becomes a GND level. Therefore, a voltage of the terminal A becomes higher than a voltage of the terminal A*, and a current IMA flows from the terminal A to the terminal A*.

The operation illustrated in FIG. 6 can be summarized as follows.

Although not illustrated, in a period before the PWM period from time T601 to time T603, the duty of the motor rotation switching signal PHA is not 50 percent. Therefore, in the PWM period from time T601 to time T603, the duty detection unit 302 sets the short-circuit brake signal SBA to a Low level (does not output the short-circuit brake signal SBA). Therefore, the instruction unit 303 outputs an instruction corresponding to this to the H-bridge circuit 204. This instruction is based on the motor rotation switching signal PHA having a duty of 50 percent. In accordance with the instruction, the H-bridge circuit 204 causes a current IMA flowing from the terminal A* toward the terminal A and a current IMA flowing from the terminal A toward the terminal A* to flow through the motor 121 in a time-division manner of 50 percent each in this period. This time-division current control is equivalent to outputting an instruction for “stopping” the motor 121 to the H-bridge circuit on average over this period.

In the PWM period from time T601 to time T603, the duty of the motor rotation switching signal PHA is 50 percent. Therefore, in a PWM period from time T603 to time T605, the duty detection unit 302 sets the short-circuit brake signal SBA to a High level (outputs the short-circuit brake signal SBA). Therefore, in this period, the instruction unit 303 outputs an instruction corresponding to this to the H-bridge circuit 204. In accordance with the instruction, the H-bridge circuit 204 mutually short-circuits the terminal A* and the terminal A of the motor in accordance with the short-circuit brake signal SBA. That is, the H-bridge control unit 201A outputs an instruction for “short-circuit braking” the motor to the H-bridge circuit.

In the PWM period from time T603 to time T605, the duty of the motor rotation switching signal PHA is 50 percent. Therefore, in a PWM period from time T605 to time T607, the duty detection unit 302 sets the short-circuit brake signal SBA to a High level (outputs the short-circuit brake signal SBA). Therefore, in this period, the instruction unit 303 outputs an instruction corresponding to this to the H-bridge circuit 204. In accordance with the instruction, the H-bridge circuit 204 mutually short-circuits the terminal A* and the terminal A of the motor in accordance with the short-circuit brake signal SBA. That is, the H-bridge control unit 201A outputs an instruction for “short-circuit braking” the motor to the H-bridge circuit.

In the PWM period from time T605 to time T607, the duty of the motor rotation switching signal PHA is 20 percent, which is not 50 percent. Therefore, in a PWM period from time T607 to time T609, the duty detection unit 302 sets the short-circuit brake signal SBA to a Low level (does not output the short-circuit brake signal SBA). In the PWM period from time T607 to time T609, the duty of the motor rotation switching signal PHA is also 20 percent. Therefore, the instruction unit 303 outputs an instruction according to the motor rotation switching signal PHA having a duty of 20 percent to the H-bridge circuit 204 in this period. In accordance with the instruction, the H-bridge circuit 204 causes a current IMA flowing from the terminal A* toward the terminal A and a current IMA flowing from the terminal A toward the terminal A* to flow through the motor 121 in a time-division manner of 80 percent: 20 percent. This time-division current control is equivalent to outputting an instruction for “reverse rotating” the motor 121 to the H-bridge circuit on average over this period.

If the duty of the motor rotation switching signal PHA is less than 50 percent in the PWM period from time T607 to time T609, the instruction unit 303 outputs an instruction for “reverse rotating” the motor 121 to the H-bridge circuit. If the duty of the motor rotation switching signal PHA exceeds 50 percent in the PWM period from time T607 to time T609, the instruction unit 303 outputs an instruction for “forward rotating” the motor 121 to the H-bridge circuit. Here, “forward rotation” and “reverse rotation” change depending on which rotation direction is made to correspond to “forward rotation,” and therefore “forward rotation” may be regarded as “reverse rotation” and “reverse rotation” may be regarded as “forward rotation.”

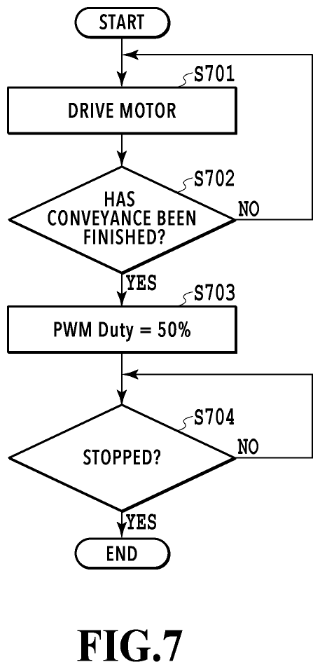

FIG. 7 is a flowchart for explaining a method for stopping a motor.

In a conveyance operation of the printing head, the processor 202 drives the CR motor 121 (S701). If the processor 202 detects that the printing head has been conveyed by a desired amount (YES in S702), the processor 202 sets a PWM duty of the motor rotation switching signal PHA to 50 percent (S703). In a first PWM period, the instruction unit 303 issues a “stop” instruction to an H-bridge circuit in accordance with the PWM signal, but in a second and subsequent PWM periods, the instruction unit 303 issues a “short-circuit brake” instruction to the H-bridge circuit in accordance with the short-circuit brake signal SBA. If the processor 202 detects a stop of the CR motor 121 (YES in S704), the processor 202 terminates the control.

As described above, according to the present embodiment, it is possible to execute both drive control and brake control using only the motor rotation switching signal PHA.

### Second Embodiment

A basic configuration of the printer 101 according to a second embodiment is similar to that of the first embodiment, and therefore a repeated description will be omitted.

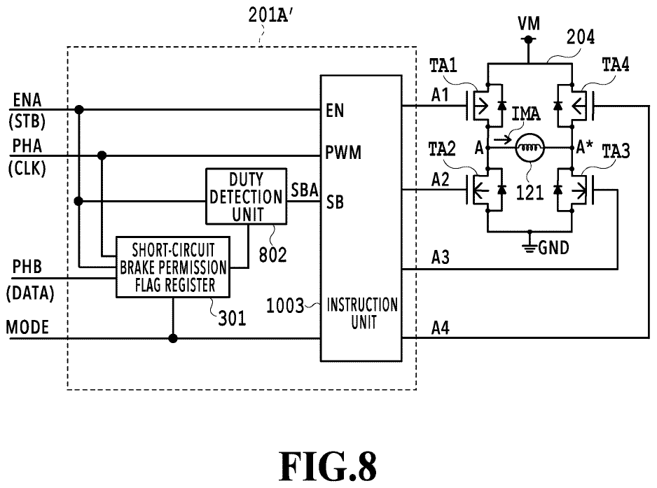

Next, details of an H-bridge control unit 201A included in the H-bridge control unit group 201 are illustrated in FIG. 8.

FIG. 8 illustrates a portion related to the H-bridge control unit 201A among H-bridge control units 201A to 201D included in the H-bridge control unit group 201. That is, FIG. 8 illustrates a portion that outputs control signals A1 to A4 to the H-bridge circuit 204. Portions related to H-bridge control units 201B to 201D also have a configuration similar to the portion related to the H-bridge control unit 201A.

The H-bridge control unit 201A outputs power transistor control signals A1 to A4 to the H-bridge circuit 204 based on a motor control signal (a motor energization permission signal ENA and a motor rotation switching signal PHA) input from the processor 202.

In a case where a setting value of a flag stored in a short-circuit brake permission flag register 301 is 1 (High) indicating permission, a duty detection unit (also referred to as “generation unit”) 802 operates as follows. That is, the duty detection unit 802 monitors a PWM duty of the motor energization permission signal ENA, and in a case where it is detected that the PWM duty is zero percent, sets a signal level of a short-circuit brake signal SBA to High. The duty detection unit 802 sets the signal level of the short-circuit brake signal SBA to Low in a case where it is detected that the PWM duty exceeds zero percent. The short-circuit brake signal SBA is supplied to a short-circuit brake input terminal SB of an instruction unit 1003. Here, that the PWM duty of the motor energization permission signal ENA as a motor control signal is zero percent means that the motor energization permission signal ENA instructs a stop. The short-circuit brake signal SBA instructs to apply short-circuit control to the motor in a case where the signal level is High. Therefore, in a case where the duty detection unit 302 determines that the motor energization permission signal ENA as a motor control signal instructs a stop of the motor, the duty detection unit 302 instructs to apply a short-circuit brake to the motor by the short-circuit brake signal SBA.

In a case where the setting value of the short-circuit brake permission flag register 301 is 0 (Low) indicating prohibition, the signal level of the short-circuit brake signal SBA is always at a Low level.

The instruction unit 1003 outputs power transistor control signals A1 to A4 of the H-bridge circuit 204 based on a motor control signal input from the processor 202 and the short-circuit brake signal SBA input from the duty detection unit 802. Here, the motor control signal includes the motor energization permission signal ENA and the motor rotation switching signal PHA.

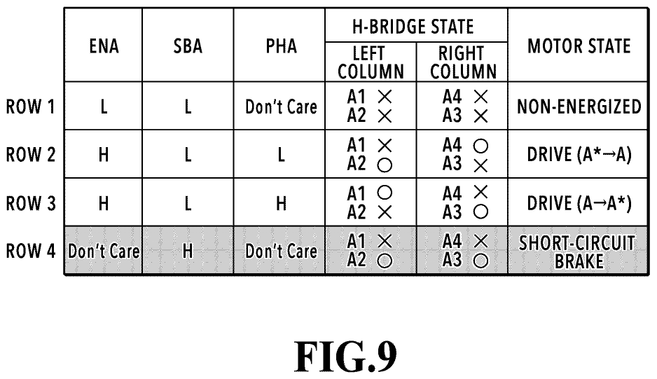

FIG. 9 shows an input/output truth table of the instruction unit 1003. The second embodiment is an application of a so-called ENABLE chopping scheme that performs energization amount control of a DC brush motor according to the duty of the motor energization permission signal ENABLE. Therefore, the input/output truth table illustrated in FIG. 9 conforms to the ENABLE chopping scheme.

Since the “H-bridge state” column of the truth table has already been described, a repeated description will be omitted.

First, a first row of the truth table indicates the following. That is, in a case where the motor energization permission signal ENA is at a Low level and the short-circuit brake signal SBA is at a Low level, the power transistors TA1 to TA4 are turned off regardless of the level of the motor rotation switching signal PHA (Don't Care). In this case, two input terminals of the motor 121 become non-energized (that is, open).

A second row of the truth table indicates the following. That is, it indicates that energization to the motor is in a possible state because the motor energization permission signal ENA is at a High level. It also indicates that a short-circuit brake instruction is in an invalid state because the short-circuit brake signal SBA is at a Low level. Furthermore, it indicates that power transistors TA2 and TA4 are on (◯) and power transistors TA1 and TA3 are off (□) because the motor rotation switching signal PHA is at a Low level. Referring to FIG. 8, in this case, a current flows from a power supply VM to GND via the power transistor TA4, the motor 121, and the power transistor TA2. That is, a current IMA flows through the motor 121 in a direction from a terminal A* to a terminal A.

A third row of the truth table indicates the following. That is, it indicates that energization to the motor is in a possible state because the motor energization permission signal ENA is at a High level. It also indicates that a short-circuit brake instruction is in an invalid state because the short-circuit brake signal SBA is at a Low level. Furthermore, it indicates that power transistors TA1 and TA3 are on (◯) and power transistors TA2 and TA4 are off (□) because the motor rotation switching signal PHA is at a High level. Referring to FIG. 8, in this case, a current flows from the power supply VM to GND via the power transistor TA1, the motor 121, and the power transistor TA3. That is, a current IMA flows through the motor 121 in a direction from the terminal A to the terminal A*.

A fourth row of the truth table indicates the following. That is, it indicates that a short-circuit brake instruction is in an enabled state because the short-circuit brake signal SBA is at a High level. For this reason, it indicates that power transistors TA2 and TA3 are on (◯) and power transistors TA1 and TA4 are off (□) regardless of the level of the motor energization permission signal ENA and the level of the motor rotation switching signal PHA (Don't Care). Referring to FIG. 8, in this case, a closed circuit of the power transistor TA2, the motor 121, the power transistor TA3, and GND is formed. That is, the terminal A and the terminal A* of the motor 121 enter a short-circuited state.

Other H-bridge control units (not illustrated) that output control signals B1 to B4, C1 to C4, and D1 to D4 to other H-bridge circuits 205 to 207 are similar to the H-bridge control unit 201A, and therefore a repeated description will be omitted.

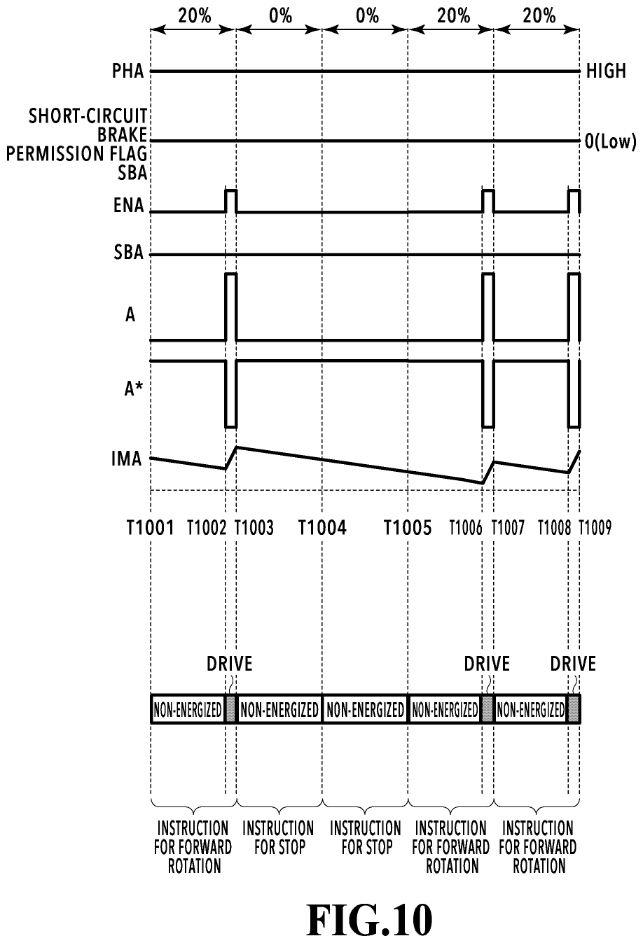

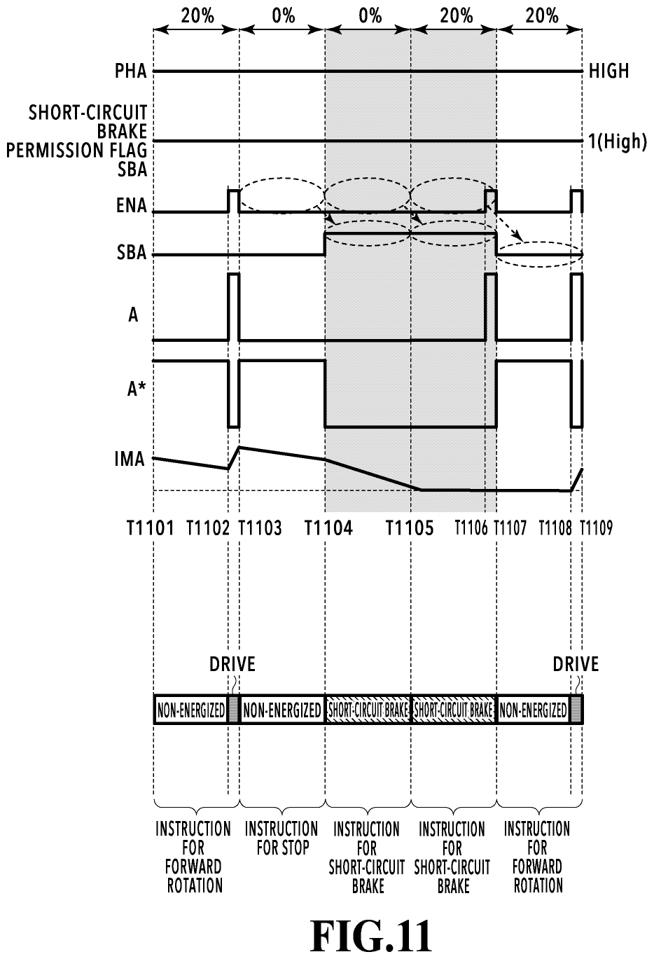

Next, an operation of the H-bridge control unit, the H-bridge circuit, and the DC motor according to the present embodiment will be described with reference to FIG. 10 and FIG. 11.

First, an operation in a case where the duty detection unit 802 is invalidated will be described with reference to FIG. 10. FIG. 10 is a timing diagram illustrating an operation of the circuit illustrated in FIG. 3 in a case where the motor rotation switching signal PHA is at a High level and a setting value of the short-circuit brake permission flag register 301 is 0 (Low). In this case, because the setting value of the short-circuit brake permission flag register 301 is 0 (Low), the duty detection unit 802 is invalidated. Therefore, the signal level of the short-circuit brake signal SBA is always at a Low level.

First, in a period from time T1001 to time T1002, the motor energization permission signal ENA is at a Low level. Therefore, in the period from time T1001 to time T1002, the motor energization permission signal ENA is at a Low level, the short-circuit brake signal SBA is at a Low level, and the motor rotation switching signal PHA is at a High level. This is the same as the state of the first row of the truth table. Therefore, the instruction unit 1003 sets the power transistor control signals A1 to A4 such that the power transistors TA1 to TA4 are turned off (□). As a result, a terminal A and a terminal A* of a motor 131 are opened (become non-energized).

Next, in a period from time T1002 to time T1003, the motor energization permission signal ENA is at a High level. Therefore, in the period from time T1002 to time T1003, the motor energization permission signal ENA is at a High level, the short-circuit brake signal SBA is at a Low level, and the motor rotation switching signal PHA is at a High level. This is the same as the state of the third row of the truth table. Therefore, the instruction unit 1003 sets the power transistor control signals A1 to A4 such that the power transistors TA1 and TA3 are turned on (◯) and the power transistors TA2 and TA4 are turned off (□). As a result, the terminal A of the motor 131 becomes a VM level, and the terminal A* becomes a GND level.

Thereafter, similarly to a period from time T1001 to time T1003, the terminal A and the terminal A* of the motor 131 are opened in a case where the motor energization permission signal ENA is at a Low level. In a case where the motor energization permission signal ENA is at a High level, the terminal A of the motor 131 becomes a VM level, and the terminal A* becomes a GND level.

In a period from time T1001 to time T1003, a duty of the motor energization permission signal ENA, which is a PWM signal, is 20 percent. Therefore, in the period from time T1001 to time T1003, the motor energization permission signal ENA instructs a “forward rotation.”

In a period from time T1003 to time T1004, a duty of the motor energization permission signal ENA is zero percent. Therefore, in the period from time T1003 to time T1004, the motor energization permission signal ENA instructs a “stop.”

In a period from time T1004 to time T1005, a duty of the motor energization permission signal ENA is zero percent. Therefore, in the period from time T1004 to time T1005, the motor energization permission signal ENA instructs a “stop.”

In a period from time T1005 to time T1007, a duty of the motor energization permission signal ENA is 20 percent. Therefore, in the period from time T1005 to time T1007, the motor energization permission signal ENA instructs a “forward rotation.”

In a period from time T1007 to time T1009, a duty of the motor energization permission signal ENA is 20 percent. Therefore, in the period from time T1007 to time T1009, the motor energization permission signal ENA instructs a “forward rotation.”

The motor rotation switching signal PHA may be at a Low level, but in this case, control for the power transistors TA1 and TA3 and control for the power transistors TA2 and TA4 are interchanged. Therefore, “forward rotation” changes to “reverse rotation.”

FIG. 10 also illustrates a current IMA flowing between the terminal A and the terminal A* of the motor 121. In a period in which the power transistors TA1 to TA4 are turned off (□), the current IMA gradually decreases. The current IMA in this period is a regenerative current. In a period in which the power transistors TA1 and TA3 are turned on (◯) and the power transistors TA2 and TA4 are turned off (□), the current IMA rapidly increases.

Next, an operation in a case where the duty detection unit 802 is enabled will be described with reference to FIG. 11. FIG. 11 is a timing diagram illustrating an operation of the circuit illustrated in FIG. 8 in a case where the motor rotation switching signal PHA is at a High level and a setting value of the short-circuit brake permission flag register 301 is 1 (High). In this case, because the setting value of the short-circuit brake permission flag register 301 is 1 (High), the duty detection unit 802 is enabled. Therefore, the short-circuit brake signal SBA becomes a High level or a Low level according to the duty of the motor energization permission signal ENA. Specifically, the short-circuit brake signal SBA becomes a High level if the duty of the motor energization permission signal ENA is zero percent, and becomes a Low level otherwise.

First, in a period from time T1101 to time T1102, the motor energization permission signal ENA is at a Low level. Although not illustrated, in a PWM period before a PWM period from time T1101 to time T1103, a duty of the motor energization permission signal ENA is not zero percent. Therefore, in a period from time T1101 to time T1103, the short-circuit brake signal SBA is at a Low level. Therefore, in the period from time T1101 to time T1102, the motor energization permission signal ENA is at a Low level, the short-circuit brake signal SBA is at a Low level, and the motor rotation switching signal PHA is at a High level. This is the same as the state of the first row of the truth table. Therefore, the instruction unit 1003 sets the power transistor control signals A1 to A4 such that the power transistors TA1 to TA4 are turned off (□). As a result, a terminal A and a terminal A* of a motor 131 are opened (become non-energized).

In a period from time T1102 to time T1103, the motor energization permission signal ENA is at a High level. Although not illustrated, as described above, in the PWM period before the PWM period from time T1101 to time T1103, the duty of the motor energization permission signal ENA is not zero percent. Therefore, in the period from time T1101 to time T1103, the short-circuit brake signal SBA is at a Low level. Therefore, in the period from time T1102 to time T1103, the motor energization permission signal ENA is at a High level, the short-circuit brake signal SBA is at a Low level, and the motor rotation switching signal PHA is at a High level. This is the same as the state of the third row of the truth table. Therefore, the instruction unit 1003 sets the power transistor control signals A1 to A4 such that the power transistors TA1 and TA3 are turned on (◯) and the power transistors TA2 and TA4 are turned off (□). As a result, the terminal A* of the motor 131 becomes a GND level, and the terminal A becomes a VM level.

In a period from time T1103 to time T1104, the motor energization permission signal ENA is at a Low level. In the PWM period from time T1101 to time T1103, the duty of the motor energization permission signal ENA is not zero percent (exceeds zero percent). Therefore, in a period from time T1103 to time T1104, the short-circuit brake signal SBA is at a Low level. Therefore, in the period from time T1103 to time T1104, the motor energization permission signal ENA is at a Low level, the short-circuit brake signal SBA is at a Low level, and the motor rotation switching signal PHA is at a High level. This is the same as the state of the first row of the truth table. Therefore, the instruction unit 1003 sets the power transistor control signals A1 to A4 such that the power transistors TA1 to TA4 are turned off (□). As a result, the terminal A and the terminal A* of the motor 131 are opened (become non-energized).

In a period from time T1104 to time T1105, the motor energization permission signal ENA is at a Low level. In the PWM period from time T1103 to time T1104, the duty of the motor energization permission signal ENA is zero percent. Therefore, in a period from time T1104 to time T1105, the short-circuit brake signal SBA is at a High level. Therefore, in the period from time T1104 to time T1105, the motor energization permission signal ENA is at a Low level, the short-circuit brake signal SBA is at a High level, and the motor rotation switching signal PHA is at a High level. This is the same as the state of the fourth row of the truth table. Therefore, the instruction unit 1003 sets the power transistor control signals A1 to A4 such that the power transistors TA2 and TA3 are turned on (◯) and the power transistors TA1 and T4 are turned off (□). As a result, the terminal A and the terminal A* of the motor 131 are mutually short-circuited.

In a period from time T1105 to time T1106, the motor energization permission signal ENA is at a Low level. In the PWM period from time T1104 to time T1105, the duty of the motor energization permission signal ENA is zero percent. Therefore, in a period from time T1105 to time T1106, the short-circuit brake signal SBA is at a High level. Therefore, in the period from time T1105 to time T1106, the motor energization permission signal ENA is at a Low level, the short-circuit brake signal SBA is at a High level, and the motor rotation switching signal PHA is at a High level. This is the same as the state of the fourth row of the truth table. Therefore, the instruction unit 1003 sets the power transistor control signals A1 to A4 such that the power transistors TA2 and TA3 are turned on (◯) and the power transistors TA1 and T4 are turned off (□). As a result, the terminal A and the terminal A* of the motor 131 are mutually short-circuited.

In a period from time T1106 to time T1107, the motor energization permission signal ENA is at a High level. In the PWM period from time T1104 to time T1105, the duty of the motor energization permission signal ENA is zero percent. Therefore, in a period from time T1105 to time T1106, the short-circuit brake signal SBA is at a High level. Therefore, in the period from time T1106 to time T1107, the motor energization permission signal ENA is at a High level, the short-circuit brake signal SBA is at a High level, and the motor rotation switching signal PHA is at a High level. This is the same as the state of the fourth row of the truth table. Therefore, the instruction unit 1003 sets the power transistor control signals A1 to A4 such that the power transistors TA2 and TA3 are turned on (◯) and the power transistors TA1 and T4 are turned off (□). As a result, the terminal A and the terminal A* of the motor 131 are mutually short-circuited.

In a period from time T1107 to time T1108, the motor energization permission signal ENA is at a Low level. In the PWM period from time T1105 to time T1106, the duty of the motor energization permission signal ENA is not zero percent (exceeds zero percent). Therefore, in a period from time T1107 to time T1109, the short-circuit brake signal SBA is at a Low level. Therefore, in the period from time T1107 to time T1108, the motor energization permission signal ENA is at a Low level, the short-circuit brake signal SBA is at a Low level, and the motor rotation switching signal PHA is at a High level. This is the same as the state of the first row of the truth table. Therefore, the instruction unit 1003 sets the power transistor control signals A1 to A4 such that the power transistors TA1 to TA4 are turned off (□). As a result, the terminal A and the terminal A* of the motor 131 are opened (become non-energized).

In a period from time T1108 to time T1109, the motor energization permission signal ENA is at a High level. In the PWM period from time T1105 to time T1106, the duty of the motor energization permission signal ENA is not zero percent (exceeds zero percent). Therefore, in a period from time T1107 to time T1109, the short-circuit brake signal SBA is at a Low level. Therefore, in the period from time T1108 to time T1109, the motor energization permission signal ENA is at a High level, the short-circuit brake signal SBA is at a Low level, and the motor rotation switching signal PHA is at a High level. This is the same as the state of the first row of the truth table. Therefore, the instruction unit 1003 sets the power transistor control signals A1 to A4 such that the power transistors TA1 to TA4 are turned off (□). As a result, the terminal A and the terminal A* of the motor 131 are opened (become non-energized).

The motor rotation switching signal PHA may be at a Low level, but in this case, control for the power transistors TA1 and TA3 and control for the power transistors TA2 and TA4 are interchanged. Therefore, “forward rotation” changes to “reverse rotation.”

The operation illustrated in FIG. 11 can be summarized as follows.

Although not illustrated, in a period before the PWM period from time T1101 to time T1103, the duty of the motor energization permission signal ENA is not zero percent. Therefore, in the PWM period from time T1101 to time T1103, the duty detection unit 802 sets the short-circuit brake signal SBA to a Low level (does not output the short-circuit brake signal SBA). Therefore, the instruction unit 1003 energizes the terminal A and the terminal A* of the motor 121 with a duty of 20 percent in accordance with the motor energization permission signal ENA having a duty of 20 percent in this period. This time-division current control is equivalent to outputting an instruction for “forward rotating” the motor 121 to the H-bridge circuit on average over this period.

In the PWM period from time T1101 to time T1103, the duty of the motor energization permission signal ENA is 20 percent. Therefore, in a PWM period from time T1103 to time T1104, the duty detection unit 802 sets the short-circuit brake signal SBA to a Low level (does not output the short-circuit brake signal SBA). In the PWM period from time T1103 to time T1104, the duty of the motor energization permission signal ENA is zero percent. Therefore, in this period, the instruction unit 1003 makes the terminal A* and the terminal A of the motor non-energized in accordance with the motor energization permission signal ENA. That is, the H-bridge control unit 201A outputs an instruction for “stopping” the motor to the H-bridge circuit.

In the PWM period from time T1103 to time T1104, the duty of the motor energization permission signal ENA is zero percent. Therefore, in a PWM period from time T1104 to time T1105, the duty detection unit 802 sets the short-circuit brake signal SBA to a High level (outputs the short-circuit brake signal SBA). Therefore, in this period, the instruction unit 1003 mutually short-circuits the terminal A* and the terminal A of the motor in accordance with the short-circuit brake signal SBA. That is, the H-bridge control unit 201A outputs an instruction for “short-circuit braking” the motor to the H-bridge circuit.

In the PWM period from time T1104 to time T1105, the duty of the motor energization permission signal ENA is zero percent. Therefore, in a PWM period from time T1105 to time T1106, the duty detection unit 802 sets the short-circuit brake signal SBA to a High level (outputs the short-circuit brake signal SBA). Therefore, in this period, the instruction unit 1003 mutually short-circuits the terminal A* and the terminal A of the motor in accordance with the short-circuit brake signal SBA. That is, the H-bridge control unit 201A outputs an instruction for “short-circuit braking” the motor to the H-bridge circuit.

In a period before the PWM period from time T1105 to time T1107, the duty of the motor energization permission signal ENA is 20 percent. Therefore, in a PWM period from time T1107 to time T1109, the duty detection unit 802 sets the short-circuit brake signal SBA to a Low level (does not output the short-circuit brake signal SBA). Therefore, the instruction unit 1003 energizes the terminal A and the terminal A* of the motor 121 with a duty of 20 percent in accordance with the motor energization permission signal ENA having a duty of 20 percent in this period. This time-division current control is equivalent to outputting an instruction for “forward rotating” the motor 121 to the H-bridge circuit on average over this period.

The method for stopping the motor described with reference to FIG. 7 is also executed in the second embodiment.

As described above, according to the present embodiment, it is possible to execute both drive control and brake control using only the motor rotation switching signal PHA.

As described above, in the present embodiment, it becomes possible to perform control of both driving and braking with one signal generation unit, signal terminal, and signal receiving unit. This eliminates the need to provide hardware dedicated to braking, and makes it easy to add a braking function to a system dedicated to driving.

### Other Embodiments

In the above-described embodiments, the printing scheme of the printing apparatus is an inkjet scheme. However, an adoptable printing scheme is not limited thereto, and may be another printing scheme such as an electrophotographic scheme or a thermal transfer scheme.

In the first embodiment, the instruction unit 303 follows a truth table as illustrated in FIG. 4. Therefore, in a case where the duty of the motor rotation switching signal PHA is less than 50 percent, the instruction unit 303 outputs a “reverse rotation” instruction to the H-bridge circuit. In a case where the duty of the motor rotation switching signal PHA exceeds 50 percent, the instruction unit 303 outputs a “forward rotation” instruction to the H-bridge circuit.

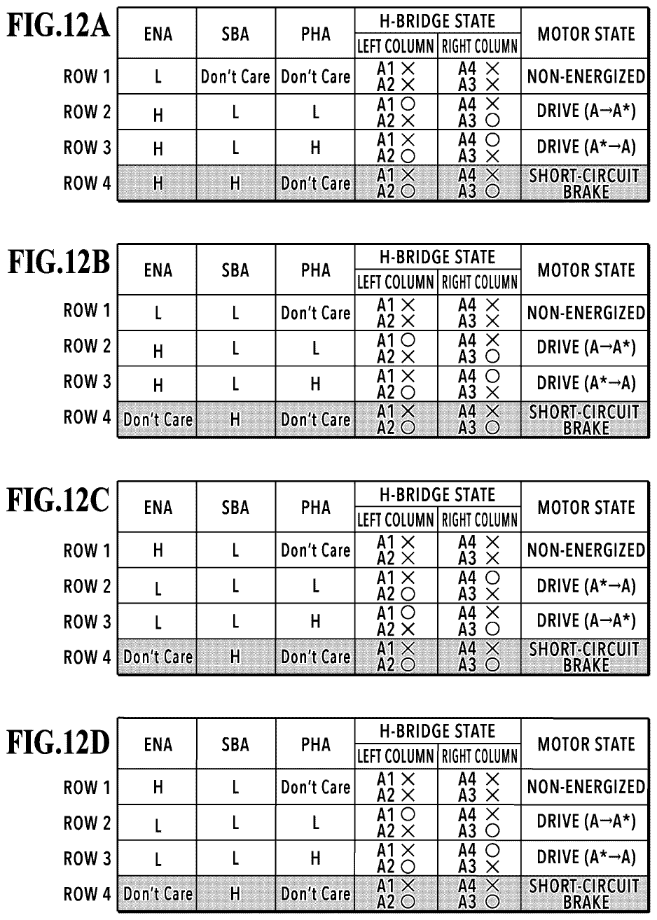

However, the present disclosure is not limited to this, and a truth table as illustrated in FIG. 12A may be followed. In this case, in a case where the duty of the motor rotation switching signal PHA is less than 50 percent, the instruction unit 303 outputs a “forward rotation” instruction to the H-bridge circuit. In a case where the duty of the motor rotation switching signal PHA exceeds 50 percent, the instruction unit 303 outputs a “reverse rotation” instruction to the H-bridge circuit.

In the second embodiment, the instruction unit 1003 follows a truth table as illustrated in FIG. 9. Therefore, in a case where the duty of the motor energization permission signal ENA is zero percent or more and the motor rotation switching signal PHA is at a Low level, the instruction unit 1003 outputs a “reverse rotation” instruction to the H-bridge circuit. In a case where the duty of the motor energization permission signal ENA is zero percent or more and the motor rotation switching signal PHA is at a High level, the instruction unit 1003 outputs a “forward rotation” instruction to the H-bridge circuit.

However, the present disclosure is not limited to this, and the instruction unit 1003 may follow a truth table as illustrated in FIG. 12B. In a case where the duty of the motor energization permission signal ENA is zero percent or more and the motor rotation switching signal PHA is at a Low level, the instruction unit 1003 outputs a “forward rotation” instruction to the H-bridge circuit. In a case where the duty of the motor energization permission signal ENA is zero percent or more and the motor rotation switching signal PHA is at a High level, the instruction unit 1003 outputs a “reverse rotation” instruction to the H-bridge circuit.

In the second embodiment, the instruction unit 1003 follows a truth table as illustrated in FIG. 9. Therefore, in a case where the duty of the motor energization permission signal ENA is zero percent, the instruction unit 1003 outputs a “stop” instruction to the H-bridge circuit.

However, the present disclosure is not limited to this, and the instruction unit 1003 may follow a truth table as illustrated in FIG. 12C. In this case, in a case where the duty of the motor energization permission signal ENA is 100 percent, the instruction unit 1003 outputs a “stop” instruction to the H-bridge circuit.

The instruction unit 1003 may also follow a truth table as illustrated in FIG. 12D. In this case, in a case where the duty of the motor energization permission signal ENA is 100 percent, the instruction unit outputs a “stop” instruction to the H-bridge circuit. In a case where the duty of the motor energization permission signal ENA is less than 100 percent and the motor rotation switching signal PHA is at a Low level, the instruction unit 1003 outputs a “forward rotation” instruction to the H-bridge circuit. In a case where the duty of the motor energization permission signal ENA is less than 100 percent and the motor rotation switching signal PHA is at a High level, the instruction unit 1003 outputs a “reverse rotation” instruction to the H-bridge circuit.

A part of the motors from the motor 121 to the motor 124 may be controlled by a circuit other than a circuit including an H-bridge control unit and a bridge circuit.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, it is possible to give a drive command and a brake command to a motor using a small number of control signals.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-201702, filed Nov. 19, 2024, which is hereby incorporated by reference herein in its entirety.

What is claimed is:

1. A motor control apparatus for controlling a motor via a drive circuit, the motor control apparatus comprising:
a generation unit configured to generate a short-circuit brake signal for applying a short-circuit brake to the motor in a case where a control signal for controlling the motor instructs a stop of the motor; and
an instruction unit configured to output an instruction for the short-circuit brake to the drive circuit in a case where the short-circuit brake signal is being generated, and to output an instruction based on the control signal to the drive circuit in a case where the short-circuit brake signal is not being generated.

2. The motor control apparatus according to claim 1, wherein the control signal is a periodic signal, and
the generation unit generates the short-circuit brake signal in a period subsequent to a period in which the control signal instructs the stop of the motor.

3. The motor control apparatus according to claim 2, wherein the instruction unit outputs the instruction generated based on the control signal to the drive circuit in a period in which the short-circuit brake signal is being generated.

4. The motor control apparatus according to claim 2, wherein the instruction unit outputs an instruction generated based on the control signal to the drive circuit in a period in which the short-circuit brake signal is not being generated.

5. The motor control apparatus according to claim 4, wherein the instruction unit outputs an instruction for forward rotation, reverse rotation, or a stop generated based on the control signal to the drive circuit in a period in which the short-circuit brake signal is not being generated.

6. The motor control apparatus according to claim 5, wherein the periodic signal is a PWM signal.

7. The motor control apparatus according to claim 6, wherein a duty of the PWM signal corresponding to the stop is 50 percent.

8. The motor control apparatus according to claim 6, wherein a duty of the PWM signal corresponding to forward rotation is less than 50 percent, and
a duty of the PWM signal corresponding to reverse rotation exceeds 50 percent.

9. The motor control apparatus according to claim 6, wherein a duty of the PWM signal corresponding to forward rotation exceeds 50 percent, and
a duty of the PWM signal corresponding to reverse rotation is less than 50 percent.

10. The motor control apparatus according to claim 6, wherein the drive circuit adjusts, according to a duty of the PWM signal, a ratio between a period in which a voltage of a first input terminal of two input terminals for driving the motor is made higher than a voltage of a second input terminal, and a period in which the voltage of the first input terminal is made lower than the voltage of the second input terminal.

11. The motor control apparatus according to claim 6, wherein a duty of the PWM signal corresponding to the stop is zero percent or 100 percent.

12. The motor control apparatus according to claim 6, wherein the drive circuit adjusts, according to a duty of the PWM signal, a ratio between a period in which a voltage of a first input terminal of two input terminals for driving the motor is made higher than a voltage of a second input terminal, and a period in which the two input terminals are opened.

13. The motor control apparatus according to claim 1, wherein in a case where the instruction for the short-circuit brake is input, the drive circuit mutually short-circuits two input terminals for driving the motor.

14. The motor control apparatus according to claim 1, wherein the drive circuit is an H-bridge circuit.

15. The motor control apparatus according to claim 1, wherein the control signal is a PWM signal, and
the generation unit determines whether the PWM signal instructs the stop of the motor based on a duty of the PWM signal.

16. The motor control apparatus according to claim 1, further comprising a permission flag register, wherein
the generation unit generates the short-circuit brake signal in a case where a flag stored in the permission flag register indicates permission and the control signal instructs the stop of the motor, and refrains from generating the short-circuit brake signal in a case where the flag stored in the permission flag register indicates prohibition.

17. The motor control apparatus according to claim 1, further comprising the drive circuit.

18. The motor control apparatus according to claim 1, further comprising a processor configured to output the control signal.

19. A printing apparatus comprising:
a motor control apparatus;
a motor;
a printing head configured to print an image on a printing medium; and
a carriage on which the printing head is mounted and configures to be moved by the motor,
wherein the motor control apparatus comprises
a generation unit configured to generate a short-circuit brake signal for applying a short-circuit brake to the motor in a case where a control signal for controlling the motor instructs a stop of the motor, and
an instruction unit configured to output an instruction for the short-circuit brake to the drive circuit in a case where the short-circuit brake signal is being generated, and to output an instruction based on the control signal to the drive circuit in a case where the short-circuit brake signal is not being generated.

20. A printing apparatus comprising:
a motor control apparatus;
a motor;
a printing head configured to print an image on a printing medium; and
a cleaning mechanism configured to clean nozzles of the printing head
wherein the motor control apparatus comprises
a generation unit configured to generate a short-circuit brake signal for applying a short-circuit brake to the motor in a case where a control signal for controlling the motor instructs a stop of the motor, and
an instruction unit configured to output an instruction for the short-circuit brake to the drive circuit in a case where the short-circuit brake signal is being generated, and to output an instruction based on the control signal to the drive circuit in a case where the short-circuit brake signal is not being generated,
wherein the motor drives the cleaning mechanism.

21. A printing apparatus comprising:
a motor control apparatus;
a motor; and
an automatic conveyance mechanism configured to take out only one sheet from a top portion from a plurality of printing media and to send the sheet to the printing apparatus
wherein the motor control apparatus comprises
a generation unit configured to generate a short-circuit brake signal for applying a short-circuit brake to the motor in a case where a control signal for controlling the motor instructs a stop of the motor, and
an instruction unit configured to output an instruction for the short-circuit brake to the drive circuit in a case where the short-circuit brake signal is being generated, and to output an instruction based on the control signal to the drive circuit in a case where the short-circuit brake signal is not being generated,
wherein the motor drives the automatic conveyance mechanism.

22. A printing apparatus comprising:
a motor control apparatus;
a motor; and
an image reading sensor configured to read an image from a document,
wherein the motor control apparatus comprises
a generation unit configured to generate a short-circuit brake signal for applying a short-circuit brake to the motor in a case where a control signal for controlling the motor instructs a stop of the motor, and
an instruction unit configured to output an instruction for the short-circuit brake to the drive circuit in a case where the short-circuit brake signal is being generated, and to output an instruction based on the control signal to the drive circuit in a case where the short-circuit brake signal is not being generated,
wherein the motor moves the image reading sensor.

23. A printing apparatus comprising:
a motor control apparatus;
a motor; and
a conveyance mechanism configured to convey a printing medium,
wherein the motor control apparatus comprises
a generation unit configured to generate a short-circuit brake signal for applying a short-circuit brake to the motor in a case where a control signal for controlling the motor instructs a stop of the motor, and
an instruction unit configured to output an instruction for the short-circuit brake to the drive circuit in a case where the short-circuit brake signal is being generated, and to output an instruction based on the control signal to the drive circuit in a case where the short-circuit brake signal is not being generated,
wherein the motor drives the conveyance mechanism.

24. A printing apparatus comprising:
a printing head configure to print an image on a printing medium;
a conveyance mechanism configured to convey the printing medium;
a cleaning mechanism configured to clean nozzles of the printing head;
an automatic conveyance mechanism configured to take out only one sheet from a top portion from a plurality of printing media and to send the sheet to the printing apparatus;
an image reading sensor configured to read an image from a document;
a motor that moves a carriage on which the printing head is mounted;
a motor that moves the conveyance mechanism;
a motor that moves the cleaning mechanism and the automatic conveyance mechanism;
a motor that moves the image reading sensor; and
a motor control apparatus corresponding to at least one of the motors
wherein the motor control apparatus comprises
a generation unit configured to generate a short-circuit brake signal for applying a short-circuit brake to the motor in a case where a control signal for controlling the motor instructs a stop of the motor, and
an instruction unit configured to output an instruction for the short-circuit brake to the drive circuit in a case where the short-circuit brake signal is being generated, and to output an instruction based on the control signal to the drive circuit in a case where the short-circuit brake signal is not being generated.

25. A motor control method for controlling a motor via a drive circuit, the motor control method comprising:
generating a short-circuit brake signal for applying a short-circuit brake to the motor, in a case where a control signal for controlling the motor instructs a stop of the motor; and
outputting an instruction for the short-circuit brake to the drive circuit in a case where the short-circuit brake signal is being generated, and outputting an instruction based on the control signal to the drive circuit in a case where the short-circuit brake signal is not being generated.
